(19) United States
(12) Patent Application Publication
(10) Pub. No.: US 2007/0004573 A1
(43) Pub. Date: Jan. 4, 2007

(54) Apparatus for the processing and/or manufacture of rod-shaped articles of the tobacco-processing industry

(75) Inventors: Stephen Wolff, Glinde (DE); Joachim Glogasa, Geesthacht (DE); Ralf Meyer, Gerdau/Bohlsen (DE)

Correspondence Address: VENABLE LLP, P.O. BOX 34385, WASHINGTON, DC, 20043-9998, US

(73) Assignee: Hauni Maschinenbau AG, Hamburg (DE)

(21) Appl. No.: 11/437,862

(22) Filed: May 22, 2006

(30) Foreign Application Priority Data
Mar. 25, 2005 (DE) 10 2005 024 645.1

(51) Int. Cl. B31C 13/00

(52) U.S. Cl. 493/4

(57) ABSTRACT

An apparatus includes at least one group of at least two adjacent sections. Each section comprises components for the processing and/or manufacturing of rod-shaped articles of the tobacco-processing industry during the transport of the articles through the section. Each section is adapted for a separate processing and/or manufacture of rod-shaped articles. Each section includes a separate guideway for the transport of the rod-shaped articles during the processing and/or manufacture, thereby making possible the simultaneous processing and/or manufacture of a plurality of rod-shaped articles corresponding to the number of sections. The at least two adjacent sections are configured in a substantially mirror-inverted arrangement relative to the transporting direction for the rod-shaped articles.

### CROSS-REFERENCE TO RELATED APPLICATIONS

This application claims the priority of German Patent Application No. DE 10 2005 024 645.1-23, filed on May 25, 2005, the subject matter of which is incorporated herein by reference. The disclosure of each U.S. and foreign patent and patent application mentioned below is additionally incorporated herein by reference.

### BACKGROUND OF THE INVENTION

The invention relates to an apparatus for the processing and/or manufacture of rod-shaped articles of the tobacco-processing industry during the transport of the articles through the apparatus.

For the present application, rod-shaped articles of the tobacco-processing industry are understood to include all objects needed for manufacturing rod-shaped smoking articles or which represent smoking articles. In particular, this relates to continuous filter rods and individual filter rods, continuous tobacco rods and individual tobacco rods, as well as filter cigarettes assembled therewith, wherein “rod-shaped” simultaneously refers to a quasi-endless continuous rod and a discrete rod shape.

The productivity can in principle be increased in two ways, namely by increasing the processing speed or by setting up several production lines. Even if progress is constantly made through increasing the processing speed, certain limits imposed by structural realities can only be crossed with considerably higher expenditures. In many cases, it is therefore preferable to increase productivity by using a parallel processing method. This is achieved with so-called multi-rod machines or systems, thereby increasing the productivity with relatively low additional design and machine expenditure and with a lower spatial requirement, as compared to the use of a corresponding number of single-rod machines or systems. For this, the aforementioned apparatus is divided into at least two sections, with each section embodied for a separate processing and/or manufacture of rod-shaped articles and provided with a separate guide-way for transporting the rod-shaped articles during the processing and/or manufacture, thus allowing the simultaneous processing and/or manufacture of a plurality of rod-shaped articles, corresponding to the number of sections used. For this, each individual section can be embodied to resemble a single-rod machine or system.

Dual-rod or multi-rod apparatuses, machines, and systems for the processing and/or manufacture of rod-shaped articles of the tobacco-processing industry are generally known. German patent document DE 43 08 093 A1, for example, discloses a dual-rod machine for processing filter tow material. German patent document DE 31 08 447 A1 discloses a device for cutting several side-by-side conveyed continuous rods in the tobacco-processing industry. German patent document DE 404 901 and British patent document GB 216868, for example, describe multi-rod cigarette makers.

### SUMMARY OF THE INVENTION

It is therefore an object of the present invention to provide a multi-rod apparatus having a more advantageous design with respect to the handling and operation as compared to presently known apparatuses.

The above and other objects are accomplished according to the invention by the provision of an apparatus, comprising: at least one group of at least two adjacent sections, each section comprising components for the processing and/or manufacturing of rod-shaped articles of the tobacco-processing industry during the transport of the articles through the section, wherein each section is adapted for a separate processing and/or manufacture of rod-shaped articles, wherein each section includes a separate guideway for the transport of the rod-shaped articles during the processing and/or manufacture, thereby making possible the simultaneous processing and/or manufacture of a plurality of rod-shaped articles corresponding to the number of sections, and wherein the at least two adjacent sections are configured in a substantially mirror-inverted arrangement, relative to the transporting direction for the rod-shaped articles.

In a further exemplary embodiment, the at least two adjacent sections include at least two, essentially side-by-side arranged parallel sections.

The inventive mirror-inverted arrangement of the sections in particular permits better access to the sections, which has advantages for the operation as well as the maintenance. In addition, the mirror-inverted arrangement according to the invention can lead to a reduction in the space requirements, not only as compared to the use of a corresponding number of single-rod machines, but also with respect to the arrangement of a traditional dual-rod or multi-rod machine.

Each individual section is configured similar to a single-rod machine and is at least partially open and/or comprises operating elements on one side, which preferably extends essentially in the direction of transport of the rod-shaped articles. The mirror-inverted configuration should furthermore be arranged such that the open side of a section faces away from the neighboring section and toward the outside, thereby permitting a clear view and access during the operation and for maintenance purposes.

An even number of sections should preferably be provided, with respectively two sections embodied in a substantially mirror-inverted arrangement, relative to the transporting direction for the rod-shaped articles. With this type of embodiment, the sections are consequently combined into groups of respectively two sections, wherein it is frequently sufficient to have only two sections of the type of a dual-rod machine.

According to another exemplary embodiment, the at least two adjacent sections are provided with respectively one cutting device having at least one rotating knife. At least one knife of the cutting device for the one section rotates in the direction opposite to the at least one knife of the cutting device for the respectively adjacent sections, thereby resulting in a particularly space-saving arrangement and embodiment of the cutting devices.

According to another exemplary embodiment of the invention there is provided an apparatus designed to process and/or manufacture rod-shaped articles of the tobacco-processing industry during the transport through the apparatus, wherein the apparatus is divided into at least two sections. Each section is embodied for a separate processing and/or manufacture of rod-shaped articles and is provided with a separate guideway for the rod-shaped articles. The guideway has a starting point and an end point, with the rod-shaped articles being transported for the processing and/or manufacture from the starting point along the guideway to the end point, so as to permit the simultaneous processing and/or manufacture of a plurality of rod-shaped articles, corresponding to the number of sections used. In this exemplary embodiment the sections are oriented relative to each other so that the spacing between the individual sections and/or groups of sections at the starting point of the guideway is shorter than at the end point of the guideway.

The sections are centrally combined in the region of the starting point for the guideways because the spacing according to the invention between individual sections and/or groups of sections at the starting point for the guideways is less than at the end point for the guideways. This type of arrangement was found to have technical advantages for the operation. The arrangement according to the invention makes it possible to have short feeding distance for the individual sections and, in the most favorable case, to supply the sections from a joint location. The fact that according to the invention the spacing between the individual sections and/or groups of sections increases toward the end point of the guideways also ensures easy access to the individual sections for the operating personnel.

Since the orientation according to the invention can be realized with individual sections as well as groups of sections, single-rod machines can be used in place of individual sections and dual-rod or multi-rod machines can be used in place of groups of sections, meaning in this case a single section also corresponds to a single-rod machine and a dual-rod or multi-rod machine corresponds to a group of sections and the apparatus can thus form a complete system.

The distance between individual sections and/or groups of sections in the starting region for the guideways should advantageously be as short as possible.

It is furthermore advantageous if the sections are essentially oriented toward a joint location at the starting point, in particular for the easy realization of the previously mentioned central feeding. According to a different modification of this embodiment, the sections are oriented approximately in a radial direction, relative to the joint location, in particular resulting in a star-shaped positioning of the sections in a semi-circular or circular arrangement.

Of course, it is also possible to arrange at least two adjacent sections approximately parallel and side-by-side in the transporting direction of the rod-shaped articles, thus forming groups of at least two parallel positioned, side-by-side arranged sections which alternatively can also be dual-rod machines, as previously mentioned.

According to a different, exemplary embodiment, raw material and material supply mechanism are provided at the starting point for the guideways. An embodiment of this type is advantageous, particularly when used with a filter-tow processing machine for producing filters for rod-shaped smoking articles, if the aforementioned raw material and material supply mechanism are filter-tow materials, which can thus be supplied over a short distance or centrally to the individual sections.

The previously stated object can furthermore be solved with a third aspect of the present invention, meaning an apparatus for the processing and/or manufacture of rod-shaped articles in the tobacco industry, by using at least one continuous rod-forming device, one cutting device, and one transfer device, wherein the continuous rod-forming device, the cutting device, and the transfer device are respectively embodied as separate modules with a defined point of intersection for connecting each module to at least one other module to form the apparatus or system.

According to the invention, a modular system is thus created, which allows the optional use of higher-value or lower-value components, as specified by the client, so as to purposely adapt the apparatus to the requirements and thus be able to obtain an optimum cost structure. The design furthermore allows using correspondingly higher-value components at system locations where high production speeds are required and correspondingly lower-value components at system locations where high production speeds are not required. Finally, the synergy effects between filter makers and cigarette makers can be utilized when using the modular design according to the invention.

For the sake of completeness, it should be mentioned that the invention is particularly suitable for the processing and/or manufacture of continuous filter rods, as well as for the processing and/or manufacture of continuous tobacco rods.

### BRIEF DESCRIPTION OF THE DRAWINGS

These and other features and advantages of the invention will be further understood from the following detailed description of the preferred embodiments and with reference to the accompanying schematic drawings, which show in:

FIG. 1 is a schematic view from the top of a preferred embodiment of the invention in the form of a dual-rod filter tow processing machine.

FIG. 2 is a schematic view from the side of the filter tow processing machine shown in FIG. 1.

FIG. 3 is a schematic view from the top of an arrangement of four filter tow processing machines of the type shown in FIG. 1.

FIG. 4 is a perspective representation of different modules, arranged to form a continuous rod maker according to yet another exemplary embodiment of the invention;

FIG. 5 is an enlarged perspective representation of a continuous rod-forming module for the continuous rod maker according to FIG. 4.

FIG. 6 is an enlarged perspective representation of a continuous rod cutting module for the continuous rod maker shown in FIG. 4.

FIG. 7a is an enlarged perspective representation of a transfer module for a first exemplary embodiment to be arranged in the continuous rod maker shown in FIG. 4.

FIG. 7b is an enlarged perspective representation of a transfer module according to a second exemplary embodiment to be arranged in the continuous rod maker shown in FIG. 4.

### DETAILED DESCRIPTION OF THE EXEMPLARY EMBODIMENTS

Referring to FIGS. 1 to 3, there is shown schematic representations of an exemplary embodiment of a dual-rod filter tow processing machine 2 for producing filters for rod-shaped smoking articles, in particular cigarettes. FIGS. 1 to 3 essentially show only the components necessary for understanding the invention. Additional machine components generally shown for system setups, for example details of the machine frame, holders, bearings, and claddings, as well as details of the individual processing machines and their units, are not shown in these Figures in the interest of a better overview. The same components are provided with the same reference numbers in all Figures.

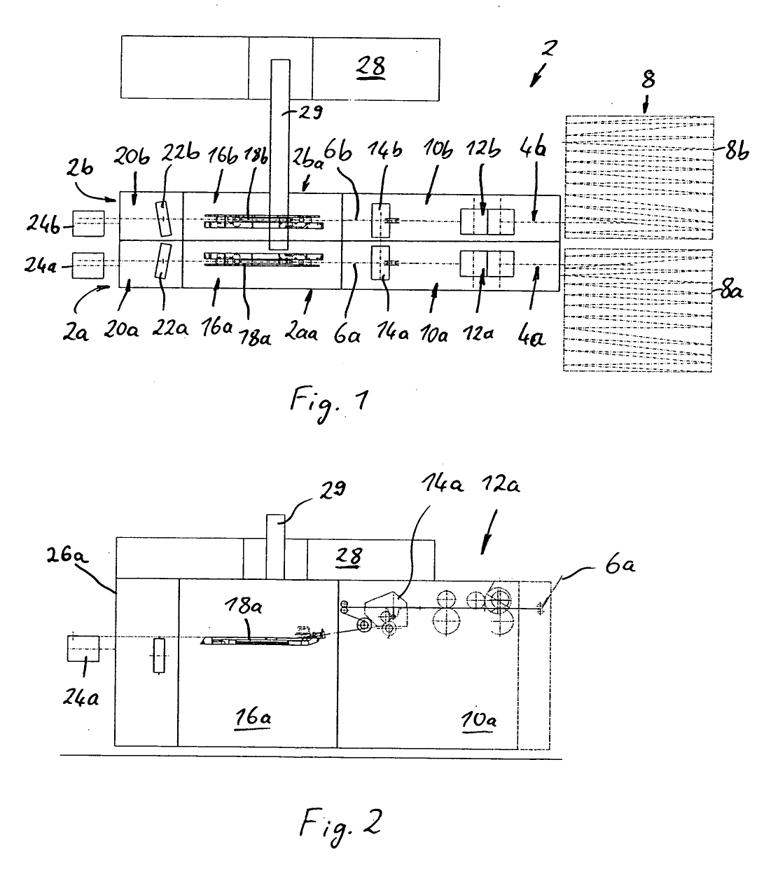

The exemplary embodiment of a filter-tow processing machine 2, illustrated herein, is a dual-rod machine that is divided into two side-by-side arranged, parallel sections 2a, 2b. Each of the two sections 2a, 2b is provided with a tow-conveying guideway or track 4a and/or 4b, which serves to guide the movement of a filter-tow ribbon 6a and/or 6b. According to FIGS. 1 and 2, the movement of the filter-tow ribbon 6a, 6b is from the right to the left.

For the exemplary embodiment shown herein, the filter tow ribbons 6a, 6b are pulled from a filter-tow supply comprising two side-by-side positioned filter tow bales 8a, 8b. For this, one filter tow bale 8a is assigned to the first section 2a, so that the filter tow ribbon 6a, which is guided along the tow guideway 4a of the first section 2a, is pulled from this filter tow bale 8a. The second filter tow bale 8b accordingly is assigned to the second section 2b, so that the filter tow ribbon 6b that is guided along the tow guideway 4b in the second section 2b is pulled from the second filter tow bale 8b. However, it is also conceivable to use only one filter tow bale which jointly comprises the ribbons 6a, 6b, or to pull a wider material ribbon from a single bale, and subsequently use a cutting device to cut the ribbon in longitudinal direction into two separate filter tow ribbons.

The first filter tow ribbon 6a is conveyed from the first filter tow bale 8a to a processing section 10a, which forms a component of the first section 2a. The second filter tow ribbon 6b moves from the second filter tow bale 8b to a corresponding processing section 10b, which forms a component of the second section 2b. The two processing sections 10a, 10b are each provided with a drawing apparatus 12a and/or 12b, wherein these respectively comprise a drawing roller or the like. The processing sections are followed by the application devices 14a and/or 14b, which supply an additional substance, generally a plasticizer.

As seen in the movement direction of the filter tow ribbons 6a, 6b, continuous rod-forming devices 16a, 16b are positioned downstream of the processing sections 10a, 10b, wherein the first continuous rod-forming device 16a forms a component of the first section 2a and the second continuous rod-forming device 16b forms a component of the second section 2b. The continuous rod-forming devices 16a, 16b are respectively provided with corresponding continuous rod-forming elements 18a and 18b, which simultaneously also function to guide the continuous filter tow rods, formed in the devices by reshaping the filter tow ribbons 6a, 6b, and to provide the filter tow rods with a paper wrapper. A glue-application device (not shown in further detail herein) at the same time glues together the paper wrapper.

As seen in the movement direction of the filter tow ribbons 6a, 6b, two cutting devices 20a, 20b are arranged downstream of the continuous rod-forming devices 16a, 16b, wherein the first cutting device 20a forms a component of the first section 2a and the second cutting device 20b forms a component of the second section 2a. The two cutting devices 20a, 20b are respectively provided with one rotating knife 22a, 22b, wherein these knives are adjusted at an angle relative to the movement direction of the filter tow rods 6a, 6b, meaning they are arranged in the horizontal direction slightly twisted or canted around a vertical line, as compared to a right-angle positioning. The knives 22a, 22b rotate in opposite directions, thereby resulting in a space-saving arrangement.

The left end region of sections 2a, 2b (according to FIGS. 1 and 2) comprises transfer devices 24a, 24b, wherein the first transfer device 24a is assigned to the first section 2a and the second transfer device 24b is assigned to the second section 2b. These transfer devices 24a, 24b are used for transferring individual filter rods, which are cut with the cutting devices 20a, 20b, to cigarette-producing machines (not shown herein).

The preceding description shows that each of the two sections 2a, 2b is configured to resemble a single-rod filter tow processing machine. Similarly as for a single-rod filter-tow processing machine, each section 2a, 2b is provided with a housing or a frame for supporting the units, as shown in FIG. 2 with the example of the housing 26a for the first section 2a. In the same way as for a single-rod filter tow processing machine, each section 2a, 2b is provided with an opening along one of its longitudinal sides, not shown in further detail herein, to provide access to the units or is otherwise embodied to allow access to the units. Control elements can furthermore be provided on each outside of each section 2a, 2b, wherein these are also not shown in the Figures. Alternatively, an arrangement of joint operating elements, used for both sections 2a, 2b, is also conceivable on a pivoting arm that is positioned in the center between the two sections 2a, 2b.

Relative to the longitudinal direction of the tow guideways 4a, 4b and thus to the movement direction of the tow ribbons 6a, 6b, the two sections 2a, 2b are configured in a mirror-inverted arrangement, relative to each other, such that they fit against each other with the longitudinal sides that are closed off by the housing or the frame. The aforementioned longitudinal sides 2aa, 2ba, which contain the openings and operating elements, respectively point toward the outside, as shown in FIG. 1, and can thus be easily accessed by the operating personnel. The mirror-inverted arrangement of the two sections 2a and 2b is furthermore illustrated with the aid of the mirror-symmetrical orientation of the rotating knives 22a, 22b in the two sections 2a, 2b. The operation can thus be observed and is accessible from both sides. Because of the improved accessibility and inspection option, the drive motors used herein can be embodied as axial cylinder motors.

In place of the illustrated two sections, it is also possible to use groups which are respectively composed of two side-by-side arranged sections, wherein these correspond to two dual rod-producing machines such as the ones used for cigarette production, but are configured in a mirror-inverted arrangement for the present application.

FIGS. 1 and 2 furthermore show a control and switch cabinet 28 for controlling and regulating the operation of the above-described dual-rod filter tow processing machine. This cabinet is connected via electrical cables conducted inside a cable duct 29 to the two sections 2a, 2b of the dual-rod filter tow processing machine 2, preferably with a completely separate control and regulation for each of the two sections 2a and 2b. Thus, the first section 2a can continue to operate, for example, while cleaning and repair work is performed on the second section 2b. Even if one of the two sections 2a, 2b fails, for example due to a break in the continuous rod, the other section and thus the dual-rod filter tow processing machine 2 can continue to operate on one side. Owing to the separate control and regulation of the sections 2a, 2b, identical as well as completely different products can be produced with the same effectiveness. Finally, it is also conceivable that the completed products are transferred in one or two mass flows to the following machine.

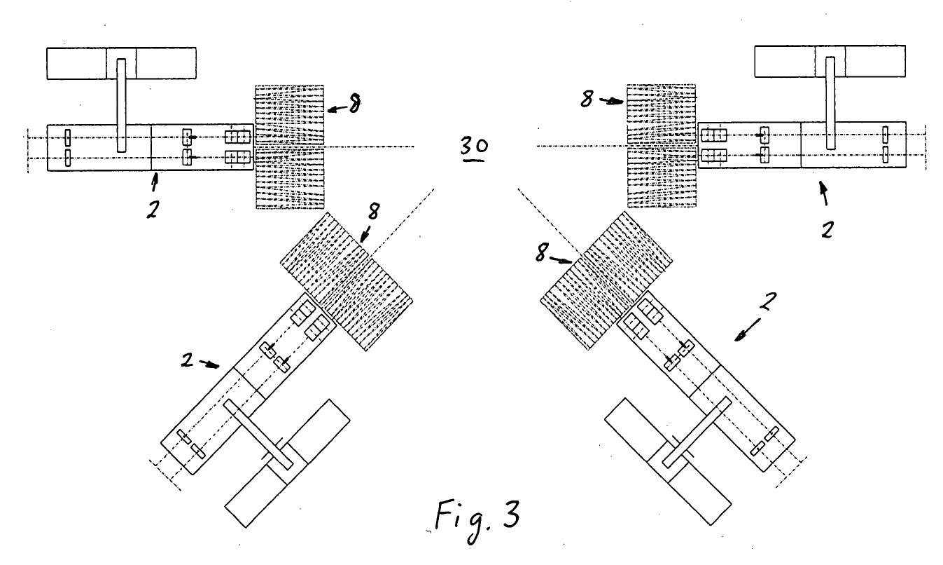

FIG. 3 shows a preferred embodiment of the invention with a special arrangement of four dual-rod filter tow processing machines 2, configured as shown in FIGS. 1 and 2.

For this special arrangement of the dual-rod filter tow processing machines 2 according to FIG. 3, the distance between the dual-rod filter tow processing machines 2 is shorter in the region of the filter tow supply means 8 and thus at the starting point of the tow guideways than in the end region where the transfer devices 24a, 24b (not shown in FIG. 3 but shown in FIG. 1) are located. In concrete terms, the four dual-rod filter tow processing machines 2 in FIG. 3 are grouped around a central location 30, approximately in a semi-circle, and are thus oriented in a radial direction toward the central location 30.

Owing to the fact that according to the exemplary embodiment shown in FIG. 3, the filter tow supplies 8 for the individual dual-rod filter tow processing machines 2 are adjacent to each other, maybe even positioned immediately next to each other, all dual-rod filter tow processing machines 2 can be supplied quickly and simply via the shortest path from the central location 30. At the same time, however, each of the dual-rod filter tow processing machines 2 remains accessible to the operating personnel on both sides as a result of the star-shaped arrangement.

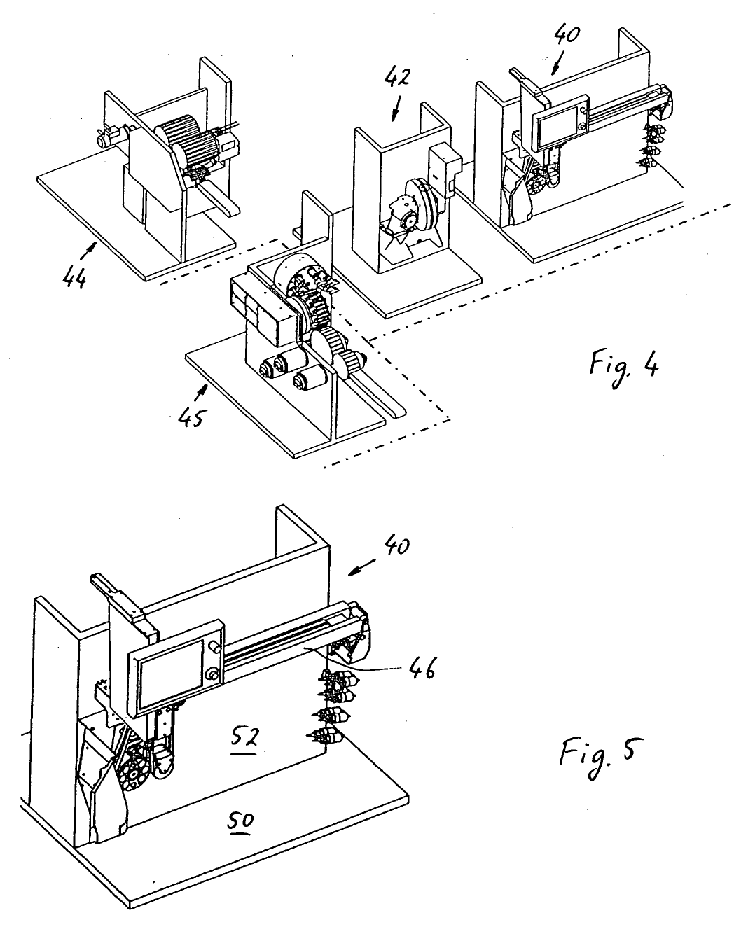

FIGS. 4 to 7b illustrate a different, preferred embodiment of a modular configuration, which is suitable not only for setting up a filter-tow processing machine of the above-described type, but is also suitable for setting up a so-called continuous-rod cigarette maker. The modules shown in FIGS. 4 to 7b can be used for setting up the firs section 2a, shown in FIGS. 1 and 2, while a mirror-inverted arrangement is necessary for the second section 2b, shown in FIGS. 1 and 2.

FIG. 4 shows examples of the most important components of a continuous-rod filter maker or cigarette maker, meaning a continuous-rod forming module 40, a continuous rod cutting module 42, and two different embodiments of a transfer module 44 and/or 45. Each of the modules is embodied with at least one defined point of intersection for connecting the module to at least one additional module in order to form a complete machine or system and to ensure a continuous transition of the rod from one module to the next module. In this way, a system of modular units is formed, which allows the optional use of higher-value or lower-value components for setting up a machine or system, tailored to the client's specifications.

FIG. 5 shows an enlarged view of the continuous-rod forming module 40 from FIG. 4, wherein the continuous rod-forming unit 46, in particular, is visible. FIG. 5 furthermore shows that the continuous rod-forming module 40 for the embodiment shown herein is provided with a base plate 50 with thereon mounted vertical frame 52, which supports the continuous rod-forming module 46. The other modules 42, 44, and 45 shown herein have a similar design.

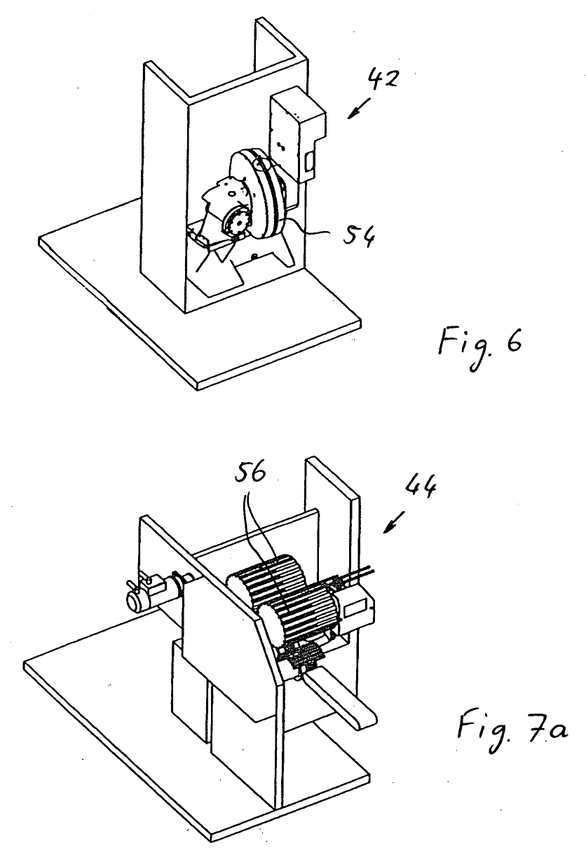

FIG. 6 shows an enlarged continuous rod cutting module 42, wherein a rotating knife 54 is visible.

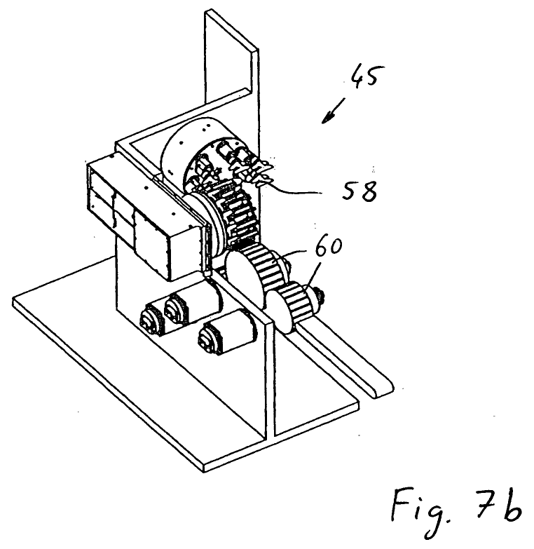

FIG. 7a shows an example of a first embodiment of a transfer module 44, which comprises pusher drums 56 with accelerating devices that are not explained further herein.

FIG. 7b shows an alternative embodiment of a transfer module 45, provided with a so-called spider 58 with down-stream arranged takeover drums 60.

Finally, it is pointed out here that all previously described embodiments are suitable not only for the processing and manufacture of filter tow and thus filters, but also for the processing and manufacture of continuous tobacco rods or individual tobacco rod sections for cigarette production.

It will be understood that the above description of the present invention is susceptible to various modifications, changes and adaptations, and the same are intended to be comprehended within the meaning and range of equivalents of the appended claims.

What is claimed is:

1. An apparatus, comprising:
at least one group of at least two adjacent sections, each section comprising components for the processing and/or manufacturing of rod-shaped articles of the tobacco-processing industry during the transport of the articles through the section,
wherein each section is adapted for a separate processing and/or manufacture of rod-shaped articles,
wherein each section includes a separate guideway for the transport of the rod-shaped articles during the processing and/or manufacture, thereby making possible the simultaneous processing and/or manufacture of a plurality of rod-shaped articles corresponding to the number of sections, and
wherein the at least two adjacent sections are configured in a substantially mirror-inverted arrangement, relative to the transporting direction for the rod-shaped articles.

2. The apparatus according to claim 1, wherein the adjacent sections of the at least one group are arranged side-by-side and essentially parallel to one another.

3. The apparatus according to claim 1, wherein each section has at least one side which is at least partially open and/or includes operating elements, wherein the at least one side of each section extends essentially in the transporting direction for the rod-shaped articles and faces away from the adjacent sections.

4. The apparatus according to claim 1, wherein the at least two adjacent sections includes an even number of sections of which respectively two sections are essentially configured in a mirror-inverted arrangement, relative to the transporting direction for the rod-shaped objects.

5. The apparatus according to claim 1, wherein the at least two adjacent sections each include one cutting device having at least one rotating knife, and the rotating knife of one cutting device for one section rotates in a direction opposite to the direction of rotation of the one rotating knife of the other cutting device for the respectively adjacent section.

6. An arrangement of apparatuses, each apparatus according to claim 1, wherein the guideway of each section has a starting point and an end point and the rod-shaped articles are transported during the processing and/or manufacture along the guideway from the starting point to the end point, and wherein the groups of sections are oriented relative to each other so that a distance between groups of sections is shorter at the starting point of the guideways than at the end point of the guideways.

7. The apparatus according to claim 6, wherein the shortest possible distance between groups of sections exists at the starting point of the guideways.

8. The apparatus according to claim 6, wherein the starting points of the guideways for the sections are substantially oriented toward a joint location.

9. The apparatus according to claim 8, wherein the sections are oriented approximately in a radial direction relative to the joint location.

10. The apparatus according to claim 6, wherein the at least two adjacent sections of each group are positioned approximately parallel and side-by-side in transporting direction for the rod-shaped articles.

11. The apparatus according to claim 6, further including a supply mechanism to supply raw material arranged at the starting point for the guideways.

12. The apparatus according to claim 11, wherein the raw material is filter-tow and the supply mechanism supplies the filter-tow to the sections for the production of filters for rod-shaped smoking articles.

13. The apparatus for the processing and/or manufacture of rod-shaped articles of the tobacco-processing industry, in particular according to claim 1, wherein the components of each section include at least one continuous rod-forming device, one cutting device, and one transfer device, wherein the continuous rod-forming device, the cutting device, and the transfer device respectively constitute separate modules, each module having a defined point of intersection for connection to at least one additional module.

14. An arrangement comprising:
at least two sections, each section comprising components for the processing and/or manufacturing of rod-shaped articles of the tobacco-processing industry during the transport of the articles through the section,
wherein each section is adapted for a separate processing and/or manufacture of rod-shaped articles,
wherein each section includes a separate guideway for the transport of the rod-shaped articles during the processing and/or manufacture, thereby making possible the simultaneous processing and/or manufacture of a plurality of rod-shaped articles corresponding to the number of sections,
wherein the guideway of each section has a starting point and an end point and the rod-shaped articles are transported during the processing and/or manufacture along the guideway from the starting point to the end point, and
wherein the sections are oriented relative to each other so that a distance between sections is shorter at the starting point of the guideways than at the end point of the guideways.

15. The apparatus according to claim 14, wherein the shortest possible distance between sections exists at the starting point of the guideways.

16. The apparatus according to claim 14, wherein the starting points of the guideways for the sections are substantially oriented toward a joint location.

17. The apparatus according to claim 14, wherein the sections are oriented approximately in a radial direction relative to the joint location.

18. The apparatus according to claim 14, further including a supply mechanism to supply raw material arranged at the starting point for the guideways.

19. The apparatus according to claim 14, wherein the raw material is filter-tow and the supply mechanism supplies the filter-tow to the sections for the production of filters for rod-shaped smoking articles.

20. The apparatus for the processing and/or manufacture of rod-shaped articles of the tobacco-processing industry, in particular according to claim 14, wherein the components of each section include at least one continuous rod-forming device, one cutting device, and one transfer device, wherein the continuous rod-forming device, the cutting device, and the transfer device respectively constitute separate modules, each module having a defined point of intersection for connection to at least one additional module.

21. An apparatus, comprising:
at least two groups each including at least two side-by-side and parallel sections, each section comprising components for the processing and/or manufacturing of rod-shaped articles of the tobacco-processing industry during the transport of the articles through the section,
wherein each section is adapted for a separate processing and/or manufacture of rod-shaped articles,
wherein each section includes a separate guideway for the transport of the rod-shaped articles during the processing and/or manufacture, thereby making possible the simultaneous processing and/or manufacture of a plurality of rod-shaped articles corresponding to the number of sections,
wherein the guideway of each section has a starting point and an end point and the rod-shaped articles are transported during the processing and/or manufacture along the guideway from the starting point to the end point, and
wherein the groups of sections are oriented relative to each other so that a distance between groups of sections is shorter at the starting point of the guideways than at the end point of the guideways.

22. The apparatus according to claim 21, wherein the shortest possible distance between groups of sections exists at the starting point of the guideways.

23. The apparatus according to claim 21, wherein the starting points of the guideways for the sections are substantially oriented toward a joint location.

24. The apparatus according to claim 21, wherein the sections are oriented approximately in a radial direction relative to the joint location.

24. The apparatus according to claim 21, further including a supply mechanism to supply raw material arranged at the starting point for the guideways.

25. The apparatus according to claim 21, wherein the raw material is filter-tow and the supply mechanism supplies the filter-tow to the sections for the production of filters for rod-shaped smoking articles.

26. An apparatus for the processing and/or manufacture of rod-shaped articles of the tobacco-processing industry, comprising at least one section including at least one continuous rod-forming device, one cutting device, and one transfer device, wherein the continuous rod-forming device, the cutting device, and the transfer device respectively constitute separate modules, each module having a defined point of intersection for connection to at least one additional module.
